(19) United States
(12) Patent Application Publication
(10) Pub. No.: US 2015/0178812 A1
(43) Pub. Date: Jun. 25, 2015

(54) ELECTRONIC LIBRARY FOR DISPLAYING BOOK TITLE COLLECTION

(71) Applicant: Kobo Inc., Toronto (CA)

(72) Inventors: Anthony O'Donoghue, Toronto (CA); James Wu, Newmarket (CA)

(73) Assignee: Kobo Inc., Toronto (CA)

(21) Appl. No.: 14/134,990

(22) Filed: Dec. 19, 2013

(51) Int. Cl. G06Q 30/06

(52) U.S. Cl. CPC G06Q 30/0631

(57) ABSTRACT

An electronic library can include book titles that the user owns, such as downloaded or archived e-books that are purchased from a network service, and book titles that the user has identified as having been read. In this way, the user's library can reflect the book titles that the user has previously read even though the user does not own or have right to possess a corresponding e-book.

### TECHNICAL FIELD

Examples described herein relate to a method or device for providing an electronic library for displaying a collection of book titles.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (e-books), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

In some instances, e-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for providing e-book services, according to an embodiment.

FIG. 2 illustrates an example of an e-reader device or other electronic personal display device, for use with one or more embodiments described herein.

FIG. 3 illustrates an e-reader system for organizing book titles, according to one or more embodiments.

FIG. 4 illustrates a method for providing a library view of book titles that the user has possession of in combination with book titles that the user has indicated as having previously read, according to one or more embodiments.

FIG. 5 illustrates an example interface for enabling the user to specify a book read input, according to an embodiment.

FIG. 6A illustrates a first example of a library view provided under an embodiment.

FIG. 6B illustrates a second example of a library view provided under an embodiment.

### DETAILED DESCRIPTION

Examples described herein include a method and device for maintaining an electronic library of book titles. In some embodiments, the electronic library can include book titles that the user owns, such as downloaded or archived e-books that are purchased from a network service, and book titles that the user has identified as having been read. In this way, the user's library can reflect the book titles that the user has previously read even though the user does not own or have right to possess a corresponding e-book.

A “book title” refers to a book as a literary work, whether embodied as an e-book, print version or other form.

In an embodiment, a collection of records are maintained, where each record of the collection identifies (i) an electronic book for which a right of possession has been acquired by the user, and (ii) a publisher's indicia for the electronic book. A feature for the user is provided to identify a book title that the user has previously read. A publisher indicia for the book title is determined. A record is stored that identifies the book title and the publisher's indicia. Additionally, the record includes data that indicates the user does not have a right of possession to an electronic book of the book title. A library representation is provided on a computing device of the user. The library representation includes the publisher indicia of the electronic book identified by one or more first records in the collection and the publisher indicia of the second record.

Among other benefits, examples described herein enable a personal display device such as an e-reader device to

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

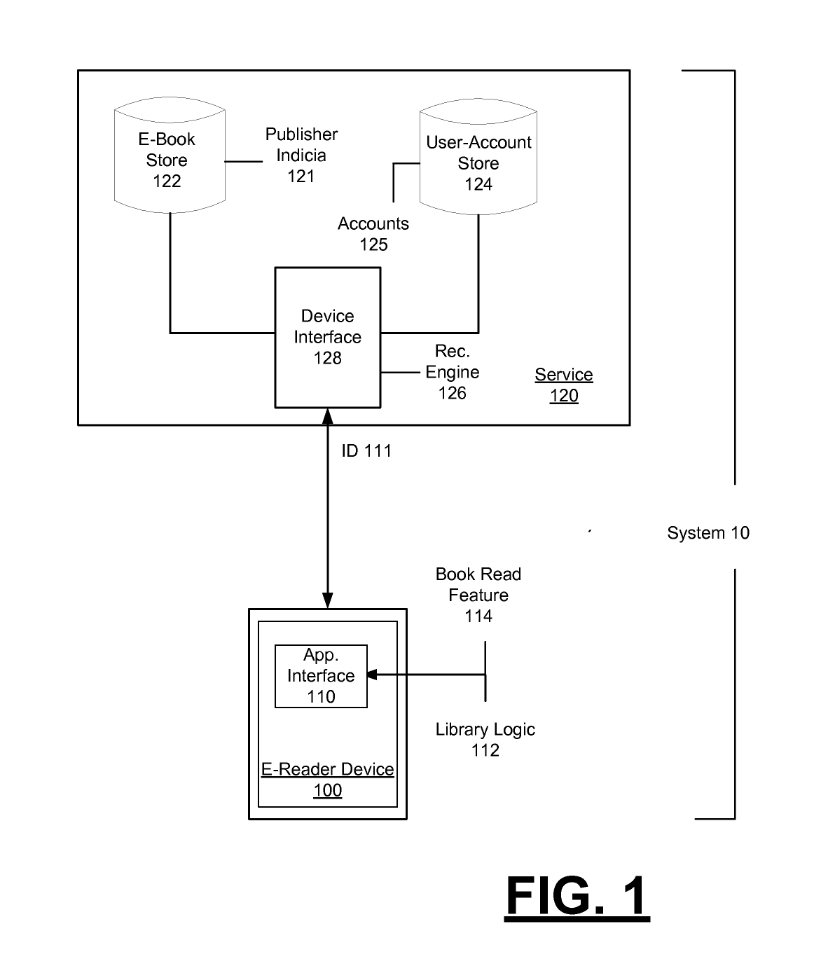

FIG. 1 illustrates a system for providing e-book services, according to an embodiment. In an example of FIG. 1, system 10 includes an electronic display device, shown by way of example as an e-reader device 100, and a network service 120. The network service 120 can include multiple servers and other computing resources that provide various services in connection with one or more applications that are installed on the e-reader device 100. By way of example, in one implementation, the network service 120 can provide e-book services which communicate with the e-reader device 100. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 100 can correspond to any electronic personal display device on which applications and application resources (e.g., e-books, media files, documents) can be rendered and consumed. For example, the e-reader device 100 can correspond to a tablet or a telephony/messaging device (e.g., smart phone). In one implementation, for example, e-reader device 100 can run an e-reader application that links the device to the network service 120 and enables e-books provided through the service to be viewed and consumed. In another implementation, the e-reader device 100 can run a media playback or streaming application that receives files or streaming data from the network service 120. By way of example, the e-reader device 100 can be equipped with hardware and software to optimize certain application activities, such as reading electronic content (e.g., e-books). For example, the e-reader device 100 can have a tablet-like form factor, although variations are possible. In some cases, the e-reader device 100 can also have an E-ink display.

In additional detail, the network service 120 can include a device interface 128, an e-book store 122 and a user account store 124. The user account store 124 can associate the e-reader device 100 with a user and with an account 125. The e-book store 122 can provide book titles that the user can acquire right of possession to, such as book titles that the user purchases. For example, the user can operate the e-reader device 100 to purchase and download e-books from e-book store 122. As an alternative or addition, the e-reader device 100 can access the e-book store 122 to download e-books on a temporal basis, such as to borrow or rent. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 100 may be associated with the user account 125, and multiple devices may be associated with the same account. As described in greater detail below, the e-reader device 100 can store resources (e.g., e-books) that are purchased or otherwise made available to the user of the e-reader device 100 through the e-book store 122, as well as to archive e-books and other digital content items that have been purchased for the user account 125, but are not stored on the particular computing device.

The e-reader device 100 includes features for providing and enhancing functionality related to displaying paginated content, and more specifically, to rendering e-books and providing e-book services. In an embodiment, the e-reader device 100 includes an application interface 110 for communicating with the network service 120. The application interface 110 can communicate a device identifier 111 to the network service 120 so that the network service links the e-reader device 100 to an account 125 of the user. The application interface 110 can include, for example, an application that accesses the network service 120 over the Internet. Among other functions, the application interface 110 can display e-books and other content provided from the network service 120.

The application interface 110 can also provide other functionality, including functionality provided by library logic 112. The library logic 112 includes functionality to display and organize information about a user's e-book collection. In one implementation, the user's e-book collection can include e-books that the user has a right of possession to, such as e-books that the user has purchased from the network service 120. The library logic 112 can identify and organize e-books that are downloaded and stored locally on the e-reader device 100. As an additional variation, the library logic 112 can identify and organize e-books (e.g., archived e-books) that are linked to the user account 125 (e.g., the user has previously purchased with another device) but which are not stored locally on the e-reader device 100. Such e-books (e.g., archived e-books) can be downloadable onto the e-reader device 100 at the selection of the user.

Additionally, the e-reader device 100 can include application and programmatic functionality for enabling the user to browse e-books from different sources, including from e-book store 122. In one implementation, the application interface 110 can communicate with a recommendation engine 126 provided by, for example, the network service 120. The recommendation engine 126 can record signals that indicate a user's interest in a genre, category, author etc., and further provide a recommendation based on the detected signals. In this way, the interface 110 can display book titles to the user as recommendations.

In some embodiments, the application interface 110 can also include a feature for enabling the user to identify book titles that the user has read, but not necessarily acquired right to purchase or otherwise download. In particular, the application interface 110 can include a book read feature 114 which can identify instances when the user encounters book titles that the user has previously read. The user can signal input through the book read feature 114 to record data that indicates the user has previously read a book title (e.g., the user has read a print version of the book title). In one implementation, the user can signal input through the book read feature 114 when browsing for e-books provided through the e-book store 122. Still further, the user can signal input through the book read feature 114 when viewing recommended book titles provided through the recommendation engine 126.

According to some embodiments, the library logic 112 can use input provided through the book read feature 114 to expand what book titles are displayed through the user's library. In particular, a library collection can be displayed through the library logic 112 that includes purchased e-books and e-books that the user has right of possession to (including archived e-books stored with network service 120), as well as book titles that the user has previously read, but which the user does not have right of possession (e.g., user cannot download e-book without purchasing the title).

Hardware Description

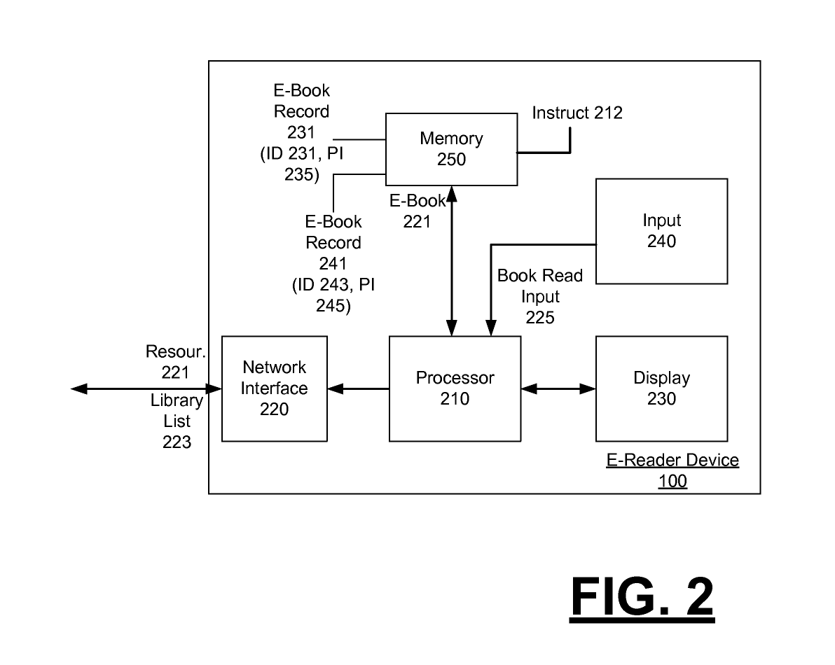

FIG. 2 illustrates an example of an e-reader device or other electronic personal display device, for use with one or more embodiments described herein. In an example of FIG. 2, an e-reader device 100 can correspond to, for example, a device, such as also shown by an example of FIG. 1. With reference to FIG. 2, e-reader device 100 includes a processor 210, a network interface 220, a display 230, and memory resources 250.

The processor 210 can implement functionality using instructions stored in the memory 250. Additionally, in some implementations, the processor 210 utilizes the network interface 220 to communicate with the network service 120 (see FIG. 1). More specifically, the e-reader device 100 can access the network service 120 to receive various kinds of resources 221 (e.g., digital content items such as e-books, configuration files, account information), as well as to provide information (e.g., user account information, service requests etc.). For example, e-reader device 100 can receive application resources 221, such as e-books or media files, that the user elects to purchase or otherwise download from the network service 120. The application resources 221 that are downloaded onto the e-reader device 100 can be stored in the memory resources 250.

As an addition or alternative, resources 221 that are received on the e-reader device 100 can include information about book titles. The information can include, for example, a publisher's indicia (e.g., book cover or illustration for the book or e-book) of an e-book for the book title. For example, the publisher's indicia about book titles can be provided in the context of recommended book titles for the user. The recommended book titles can be communicated from, for example, a recommendation engine 126 (see FIG. 1) provided with network service 120.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the input mechanisms 240, the display 230 or other input mechanisms (e.g., buttons, keyboard, microphone, etc.). With reference to examples described herein, the processor 210 can generate output on the display 230 to prompt the user for a response (e.g., selection input), and further respond to input provided by the user through the input mechanism 240. In one embodiment, the processor 210 identifies input from the user that corresponds to (i) the user browsing book titles for purchase or download, (ii) the user selecting e-books for download or purchase, (iii) the user archiving e-books, and (iv) the user performing page viewing activities with a rendered e-book. Still further, in some embodiments, the processor 210 generates a prompt via the display 230, and detects a corresponding input from the user that corresponds to a book read input 225. The book read input 225 reflects a designation by the user that a particular book title has previously been read by the user. For example, the book read input 225 can register that the book title that the user has encountered (e.g., when browsing or receiving recommendations) was one that the user has previously read (e.g., the user read a paperback or hard cover version of the book).

The processor 210 can also implement instructions 212 for implementing library logic 112 (see FIG. 1). The instructions 212 can be stored with the memory resources 250. The library logic can be implemented by the processor 210 to generate lists that reflect sets of e-books or book titles.

In addition to storing application resources 221 (e.g., e-books, publisher indicia etc.) and programmatic instructions, the memory resources 250 can maintains sets of records that correspond to a collection of e-books or book titles. In particular, the memory resources 250 can include (i) a collection of records 231 that individually identify e-books that the user has downloaded and/or has right to download (e.g., user has right to possession by virtue of having previously purchased the e-book), (ii) a collection of records 241 that individually identify book titles that the user has marked as having previously been read. Each record 231 in the collection (e-books that the user has downloaded or has rights to) can include an identifier 233 and a publisher's indicia 235 (e.g., publisher's illustration or book cover) for the e-book, as well as a pointer or other association to a local or archived copy of the corresponding e-book (which can be received as an example of application resources 221). Each record 241 in the collection can include (i) an identifier to an e-book version of the book title, such as an identifier 243 that locates the particular e-book on the e-book store 122 of the network service 120; and (ii) the publisher's indicia 235 (e.g., publisher's illustration or book cover) for the book title or the e-book version of the book title. Still further, in one implementation, each record 243 in the collection can include a link that enables the user to immediately purchase or download the e-book that corresponds to the identified book title.

According to some embodiments, the processor 210 can execute instructions 212 for implementing library logic using the collection of records 231, 241. Among other functions, the processor 210 implements the instruction 212 in order to generate lists from the collection of records 231, 241. The lists can be displayed in a variety of context, such as virtual book shelves, and use the publisher's indicia 235 of e-book titles that the user has possession of, as well as publisher's indicia 235 for book titles that the user has marked as having read (but which the user does not have right to electronic version).

E-Reader System

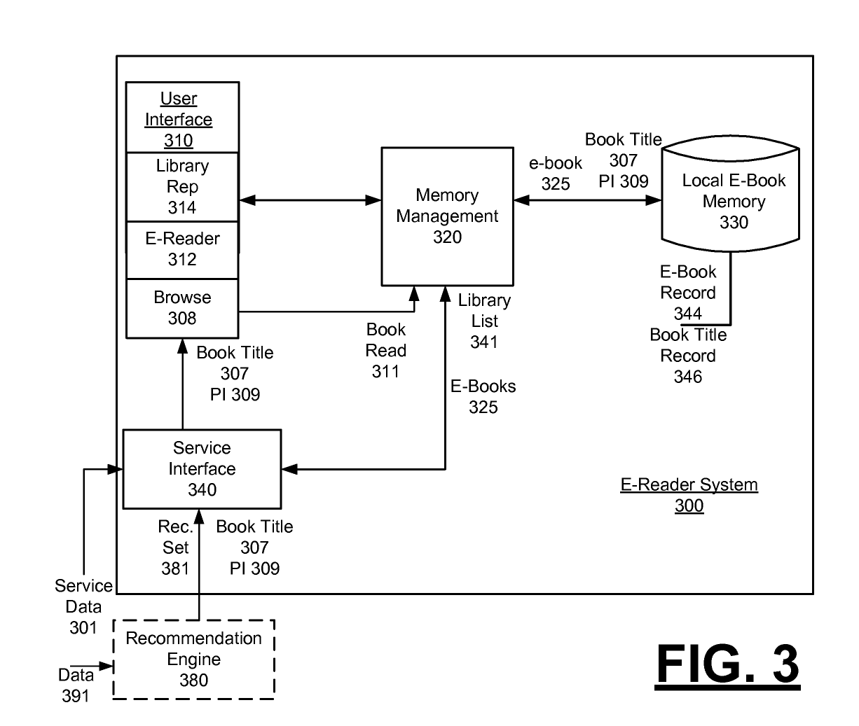

FIG. 3 illustrates an e-reader system for organizing book titles, according to one or more embodiments. An e-reader system 300 can be implemented as for example, an application or device, using components that execute on, for example, an e-reader device such as shown with examples of FIG. 1, or FIG. 2. Furthermore, an e-reader system 300 such as described can be implemented in a context such as shown by FIG. 1 and FIG. 2. In reference to FIG. 3, an e-reader system 300 can implement programmatic components for communicating with an e-book service (such as network service 120, shown in FIG. 1), as well as for enabling organization of e-books utilized by an account associated with the e-reader device 100. In some implementations, the e-reader system 300 can be implemented as an application that runs on the e-reader device 100 (e.g., such as shown by FIG. 1 or FIG. 2).

In an example of FIG. 3, the e-reader system 300 includes a user interface 310, a memory management module 320, a local memory 330, and a service interface 340. The programmatic components shown with the e-reader system 300 can be provided as part of an application that runs on the e-reader device 100. For example, the user can download an application onto a mobile computing device in order to obtain functionality such as described herein, as well as to communicate with a network service 120. Alternatively, the application can be embedded or otherwise preinstalled with other programmatic elements for providing such functionality on a computing device.

The service interface 340 includes application and logic which enables the device to use, for example, a wireless Internet connection, to connect to the network service 120 (see FIG. 1). In connecting with the service, the service interface 340 can transmit data that enables the network service 120 to identify e-reader system 300 (or alternatively the user) so that the network service 120 can determine the account associated with the mobile computing device. The service interface 340 can receive service data 301 from the network service 120. The service data 301 can include e-books 325, including e-books purchased or downloaded from the network service 120. For example, in identifying the e-reader system 300 with the network service 120, the network service may be able to procure payment information (e.g., stored credit card) that can be used to charge users account when purchasing a new e-book. Each e-book can correspond to a literary work, having pagination, chapter designations and optionally graphics and formatting. Individual e-books 325 can also include publisher's indicia in the form of graphic representations 327, such as icons, that provide imagery for marketing the e-book similar to the manner in which a conventional hardbound book would be marketed in a retail store. In one implementation, the network service 120 can retrieve or otherwise identify the graphic representations 327 of individual e-books from publisher sources.

In identifying the e-reader system 300, the network service 120 can identify what e-books belong to the account of that device. E-books that are transmitted to the e-reader system 300 include those that are purchased from the device, or those that the user requested to download. The user can be deemed to have a right of possession to an e-book version of a book title when the user rightfully downloads or acquires the right to download an e-book.

In variations, e-books can automatically be downloaded to the device in response to the occurrence of certain conditions. For example, the user can purchase an e-book on another device, and then subsequently connect to the network service 120 via the e-reader system 300 to automatically receive their previously purchased e-book. Alternatively, network service 120 can be configured to push e-books to the e-reader system 300, based on, for example, user account settings, subscription rules, and various other business logic consideration.

According to some embodiments, the local memory 330 stores each e-book 325 as a record 344 that includes content (e.g., page content). The local memory 330 can retain a record 344 of each e-book that the user has downloaded, or can download (e.g., archived e-book). In one implementation, the record 344 includes the publisher's indicia 309, which can be in the form of a graphic representation, as well as other metadata that is used to represent the e-book as an entry in one of the lists. The record 344 can also link to the content of the e-book 325. The content of the e-book 325 can be stored locally (e.g., with local memory resource 330) or remotely (e.g., with the user account 125 on the network service 120).

In one variation, the user can specify input (e.g., via the user interface 310) in order to selectively archive an e-book 325 stored in the local memory 330. In another variation, the memory management module 320 can archive e-books 325 based on a setting (e.g., archive e-books that have been read or downloaded more than a year ago). According to one aspect, the memory management module 320 can implement an archiving operation by maintaining the record 344 of each archived e-book in the local memory 330. The archiving operation can delete or otherwise remove from memory 330 the contents 328 of an e-book that is archived, corresponding to, for example, some or all of the pages of the e-book that have been selected for removal from the device.

Among other functionality, the user interface 310 can include an e-book browser 308, an e-reader 312, and a library viewer 316. The e-reader 312 can correspond to a program that renders e-books for the user. The e-reader 312 can, for example, display paginated content such as e-books, as well as other content such as electronic magazines and web pages. The e-reader 312 can also provide interface features that enable the user to flip through electronic pages or chapters of an e-book.

In one implementation, the e-book browser 308 enables the user to browse book titles with the e-book store 122 provided with network service 120. For example, the e-book browser 308 can enable the user to search for e-books to purchase, including selecting to browse categories of e-books by genre or sub-genre.

In one implementation, the e-book browser 308 can interact with a recommendation engine 380. In one implementation, the recommendation engine 380 is operated from the network service 120, and provides a set of recommendations 381 to the browser 308 via the service interface 340. In a variation, the recommendation engine 380 can operate locally using recommendation data 391 provided from the network service 120. The set of recommendations 381 can include book titles that are likely of interest to the user, based on output from the recommendation engine 138. In providing the set of recommendations, the recommendation engine 138 can utilize signals such as e-books that the user purchases, downloads, reads or researches. The e-book browser 308 can be used to render information about the book titles of the recommended set 381. For example, the e-book browser 308 can render the book title 307 and a corresponding publisher indicia 309 (e.g., graphics). The e-book browser 308 can record input from the user indicating one of (i) acquire input, indicating the user's interest in downloading an e-book for the book title 307, (ii) ignore or dislike input, indicating the user is not interested in acquiring an e-book for the book title 307, or (iii) book read input 311, indicating the user has previously read the book title.

In some embodiments, when the book read input 311 is provided, the memory management module 320 stores a record 346 that identifies the book title 307 and the publisher indicia 309 for the book title. The record 346 further includes data that indicates the user does not have a right to download or possess the e-book of the book title. Accordingly, the memory resource 330 can retain a first collection of records 344, corresponding to e-books that the user has right of possession for (e.g., e-books the user has purchased, downloaded or archived), and a second collection of records 346, corresponding to e-books that the user has indicated as having previously been read by the user.

The library viewer 316 enables the display of data representing the records 344, 346, maintained in the memory resource 330. The library viewer 316 can display each record 344, 346 as an entry in a collection of entries, which individually represent book titles identified by the records 344, 346 stored with the memory resource 330. In one aspect, each entry can include some information about a corresponding e-book, such as title, author, user rating, some textual characterization (e.g. tags re-summary), and status information as to whether the user has read the book or spent time viewing the book. Additionally, each entry of the various lists can include the publisher indicia 309 (e.g., graphic representation, such as book cover, jacket or illustration) of the corresponding e-book 325.

The library viewer 316 can utilize any one of multiple visual frameworks to display entries of records 344, 346. For example, the library viewer 316 can display entries of records 344, 346 as lists, or as items on a virtual shelf, or still further as items on a virtual bookcase. The entries that represent records 344 can include the publisher indicia 309 provided with the corresponding e-books 325. In one variation, the entries for records 344 that represent e-books that the user has archived can be provided with publisher indicia and a link that enables the e-book to be automatically downloaded upon selection. Still further, the entries for records 346 representing e-books that the user has marked as having previously been read can be provided with the publisher indicia 309. Other information, such as the status of the book title (e.g., indicia indicating no e-book right has been obtained) can also be displayed as part of the entry. Still further, library viewer 316 can provide the entry for record 346 with a link that enables the user to purchase or otherwise obtain rights to downloading an e-book version of the particular e-book title. For example, the entry can include a feature that links to the network service 120 and identifies the e-book for the book title, as well as the account of the user

Methodology

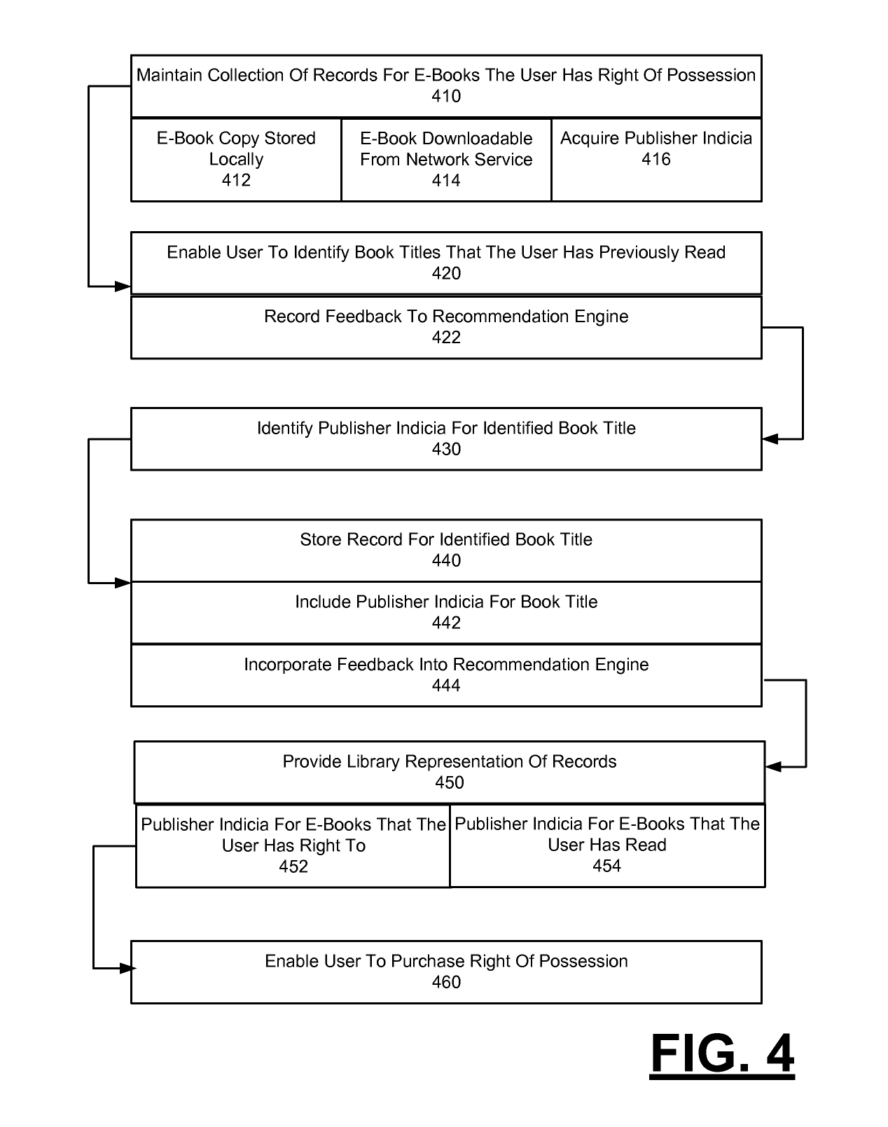

FIG. 4 illustrates a method for providing a library view of book titles that the user has possession of in combination with book titles that the user has indicated as having previously read, according to one or more embodiments. An example such as provided with FIG. 4 can be implemented using, for example, components such as provided with examples of prior figures, such as FIG. 2. Accordingly, reference may be made to elements of other examples for purpose of illustrating suitable components for performing a step or sub-step being described.

With reference to an example of FIG. 4, e-reader device 100 can maintain a collection of records that individually represent e-books for which the user has a right of possession to, such as a rightful download copy (410). In particular, the records 231, for example, can each represent an e-book that the user has acquired by purchase (412). In a variation, the record 231 can indicate an e-book title that the user has acquired by purchase, but then archived (414). Each record of the collection can include (i) publishers indicia, including text and images about the book title (e.g., summary, author name and biography) and other metadata, (ii) a pointer or link to a content portion of the e-book.

The e-reader device 100 can also include functionality for enabling the user to identify book titles that the user has previously read (420). The ability of the user to specify such e-book titles can be provided in different operating context. In one implementation, the e-reader device 100 can provide recommendation engine 380 to provide book titles as recommendations to the user, and the feedback of the user to recommended titles can be recorded (422). In particular, the recommendation engine 380 can utilize different signals for making recommendations, such as book titles the user has downloaded, read, purchased, or reviewed. In one embodiment, when the recommendation engine 380 suggests a book title for the user, the user can provide feedback that indicates whether the user has previously read the book title. For example, the user may have previously read a recommended book title as a paperback, and the user feedback can specify that the user has read the book title. The feedback to the output of the recommendation engine 380 can alternatively specify the interest level of the user, such as whether the user wants to receive more recommendations of the category or from the same author, or whether the user downloaded the book title.

In an embodiment, the feedback to the recommended book title is received and incorporated to provide additional recommendations (424). For example, if the user responds to the recommended book title by indicating the user previously read the book title, the feedback can be used as a signal that updates e-books for recommendation to the user. The user marking the book title as having been read can, for example, indicate a user's preference for the genre, category or author of the read title.

In a variation, the user can mark a book title as read when the book title is encountered in other operating environments. For example, the user can mark a book title as being read when viewing information about an e-book from the e-book store 122 of the network service 120.

When a book title is identified as being read, the publisher indicia for the book title can be identified (430). For example, the output of the recommendation engine 380 can include publisher indicia for each recommended book title, and the publisher indicia can then be recorded. In a variation, the publisher indicia for the identified book title can be obtained independently from another source (e.g., than the recommendation engine 380). Thus, for example, the image (e.g., book or spine) identified for the book title can be different than that used to prompt the user for book read input.

In an embodiment, a record 346 is stored on the e-reader device 100, corresponding to the identified book title that the user previously read (440). The record 346 can include the publisher indicia, such as the book cover, spine, or other illustration. Such book title information can be included as part of the record 346 when the user provides input that indicates the user read the e-book (442). In particular, the processor 210 of the e-reader device can identify or retrieve the publisher indicia for book titles that are identified as having been read by user input (e.g., book read input 225, FIG. 2).

A library representation is provided based on the collection of records stored on the e-reader device (450). The library representation can include the publisher indicia for e-books that the user has downloaded, purchased or otherwise obtained rights for possession to (452). Additionally, the library representation can include the publisher indicia for e-books that the user has indicated as having been read (e.g., with book read input 225) (454). The library representation can display the publisher indicia of the various records in different forms, such as in a list, book shelf (e.g., display jacket cover for e-book titles) or as a virtual book shelf). For e-books that the user has locally stored or right to download, the user can access the content from the library representation without, for example, taking steps to acquire rights to the particular e-book (e.g., purchase). For those records that the user identified as having read, the publisher indicia can be displayed without the content portion of the book title.

In a variation, the library representation can include a feature to facilitate acquisition of an e-book version of the book title that the user marked as having previously been read (460). In one implementation, the publisher indicia of the book title marked as having been read can be provided with an icon or link to enable the user to purchase the e-book version of the book title. For example, the icon can be displayed with the cover or jacket image of an e-book version of the identified book title. The icon can be selectable, and link to the network service 120. When selected, the link to the network service 120 can identify the e-book title and information about the user account in order to automate purchase of the e-book.

### EXAMPLES

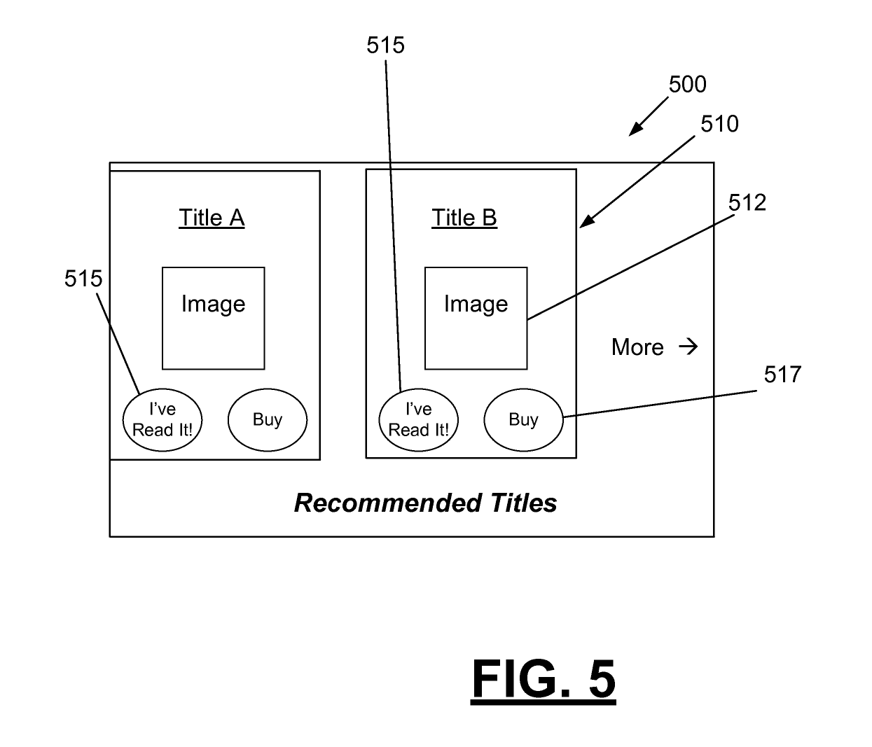

FIG. 5 illustrates an example interface for enabling the user to specify a book read input, according to an embodiment. In an example of FIG. 5, an interface 500 includes book title images 510 that comprise a set of recommended book titles for the user. For example, interface 500 can be provided in context of an output of a recommendation engine that recommends book titles to the user. The book title images 510 include publisher indicia for a given book title. The publisher indicia can include the cover or jacket image 512, along with other information (e.g., author, summary etc.). The interface 500 can include a feature 515 that enables the user to provide feedback that includes input indicating the user has previously read the book title. The feature 515 can correspond to the user indicating that they have read the book title. Other features 517 can trigger an action, such as acquisition or purchase of the e-book from the network service 120.

In a variation, the interface 500 can be provided in the context of the user browsing an online store for e-books. For example, with reference to FIG. 1, the interface 500 can be provided as an interface for the e-book store 122 of network service 120.

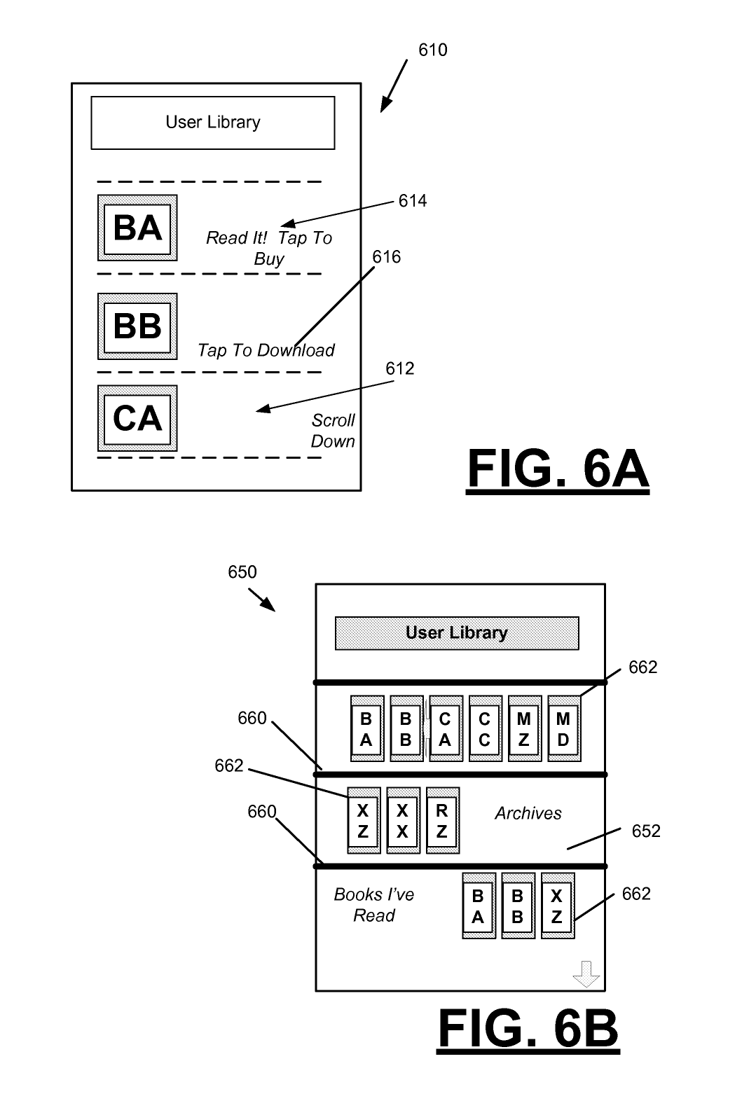

FIG. 6A and FIG. 6B each illustrate examples of library views, according to one or more embodiments. With examples of FIG. 6A and FIG. 6B, the respective library views can combine information about e-books that the user has right of possession to (e.g., those the user has downloaded) with information about book titles that the user has previously read. By way of example and with reference to FIG. 2, the library views of examples provided by FIG. 6A and FIG. 6B can be generated by processor 210 implementing instructions stored in the memory resource 250, and further utilizing e-book information (e.g., records 231, 241) stored with the memory resources 250. Still further, with reference to FIG. 3, the library views provided by FIG. 6A and FIG. 6B can be implemented by user interface 310, including library viewer 316, using information (e.g., records 344, 346) provided in the local memory 330.

In an example of FIG. 6A, library view 610 can provide a categorized or sorted arrangement of e-books. The library view 610 can be scrollable. The e-books can be individually, or by clusters, marked with a first indicia 612 indicating that the user has a right to possess the e-book, or with a second indicia 614 as a result of the user identifying the book title as having previously been read. Still further, an indicia 616 may indicate the title is owned but archived.

FIG. 6B illustrates a library view 650 in a form of a book case. Individual book shelves 660 can delineate the presentation 662 of book titles by category (e.g., genre, author), designation (book titles that the user owns, book titles that the user owns but archives, book titles that the user has read, but does not own) or other parameter (e.g., recently read, user setting).

With examples such as depicted by FIG. 6A and FIG. 6B, a user's virtual library can be supplemented with publisher indicia of book titles that the user has read. The publisher indicia can be provided without the content. In this way, the library can show the publisher indicia of an e-book version of the title, without providing the content portion of the e-book. Among other benefits, the user is able to view the electronic library for book titles the user has read, rather than e-books that the user has downloaded or purchased.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

1. A method for maintaining a collection of electronic books, the method being implemented by one or more processors and comprising:
maintaining a collection of first records for a user, each first record in the collection identifying (i) an electronic book for which a right of possession has been acquired by the user, (ii) a publisher's indicia for the electronic book;
providing a feature for the user to identify a book title that the user has previously read;
determining a publisher's indicia for the book title;
storing a second record that identifies the book title and the publisher's indicia, the second record further including data that indicates the user does not have a right of possession to an electronic book of the book title; and
providing a library representation on a computing device of the user, the library representation including the publisher indicia of the electronic book identified by one or more first records in the collection and the publisher indicia of the second record.

2. The method of claim 1, wherein determining a publisher's indicia for the book title include determining the publisher's indicia for the electronic e-book of the book title.

3. The method of claim 1, further comprising providing a recommendation service for the user to recommend book titles that the user may enjoy, and wherein providing the feature includes enabling the user to specify input that indicates that the user has previously read a book title that was recommended by the recommendation service.

4. The method of claim 3, further comprising updating data used by the recommendation service in recommending book titles to the user in response to a user input indicating that the user has previously read a book title that was recommended by the recommendation service.

5. The method of claim 1, wherein providing the library representation includes displaying one or more lists of book titles that include the publisher indicia of one or more first records of the collection and the publisher indicia of the second record.

6. The method of claim 1, wherein the publisher's indicia of the electronic book identified by each first record of the collection includes a book cover image provided for that electronic book by the publisher, and wherein determining the publisher's indicia for the book title includes determining a book cover image for an electronic book version of the book title.

7. The method of claim 6, wherein providing the library representation includes providing a book shelf representation on a computing device of the user that includes the book cover image of the electronic book identified by each of one or more first records of the collection and by the book cover image for the electronic book version of the book title identified by the second record.

8. The method of claim 1, wherein providing the library representation includes providing a feature with the publisher indicia of the second record that enables the user to acquire a right of possession to an electronic book version of the book title.

9. The method of claim 1, further comprising storing a plurality of second records, each of the plurality of second records identifying a corresponding book title that the user has previously identified as having been read, each second record including data indicates that the user has not purchased the right of possession to an electronic book of the corresponding book title, and wherein providing the library representation includes displaying a set of multiple publishers indicia for book titles identified by multiple second records in the plurality of second records.

10. The method of claim 9, wherein providing the library representation includes displaying together the publisher indicia for book titles identified by multiple second records in the set of records.

11. A computing device comprising:
a memory resource;
a processor;
a display;
wherein the memory stores a collection of first records for a user, each first record in the collection identifying (i) an electronic book for which a right of possession has been acquired by the user, (ii) a publisher's indicia for the electronic book;
wherein the processor operates to:
provide a feature for the user to identify a book title that the user has previously read;
determine a publisher's indicia for the book title;
store, in the memory resources, a second record that identifies the book title and the publisher's indicia, the second record further including data that indicates the user does not have a right of possession to an electronic book of the book title; and
provide, using the display, a library representation, the library representation including the publisher indicia of the electronic book identified by one or more first records in the collection and the publisher indicia of the second record.

12. The computing device of claim 11, further comprising a network interface, and wherein the processor uses the network interface to retrieve, from a network site, the publisher's indicia for the book title.

13. The computing device of claim 11, wherein the processor operates to provide a recommendation service for the user to recommend book titles that the user may enjoy, and wherein provides the feature by enabling the user to specify input that indicates that the user has previously read a book title that was recommended by the recommendation service.

14. The computing device of claim 13, wherein the processor updates data used by the recommendation service in recommending book titles to the user in response to a user input indicating that the user has previously read a book title that was recommended by the recommendation service.

15. The computing device of claim 11, wherein the processor provides the library representation by displaying one or more lists of book titles that include the publisher indicia of one or more first records of the collection and the publisher indicia of the second record.

16. The computing device of claim 11, wherein the publisher's indicia of the electronic book identified by each first record of the collection includes a book cover image provided for that electronic book by the publisher, and wherein the processor determines the publisher's indicia for the book title by determining a book cover image for an electronic book version of the book title.

17. The computing device of claim 16, wherein the processor operates to provide the library representation by providing a book shelf representation using the display, the book shelf representation including the book cover image of the electronic book identified by each of one or more first records of the collection and by the book cover image for the electronic book version of the book title identified by the second record.

18. The computing device of claim 11, wherein the processor operates to provide the library representation by providing a feature with the publisher indicia of the second record that enables the user to acquire a right of possession to an electronic book version of the book title.

19. The computing device of claim 11, wherein the processor operates to store a plurality of second records, each of the plurality of second records identifying a corresponding book title that the user has previously identified as having been read, each second record including data indicates that the user has not purchased the right of possession to an electronic book of the corresponding book title, and wherein the processor provides the library representation by displaying a set of multiple publishers indicia for book titles identified by multiple second records in the plurality of second records.

20. (canceled)
